(19) United States
(12) Patent Application Publication
(10) Pub. No.: US 2025/0220654 A1
(43) Pub. Date: Jul. 3, 2025

(54) METHOD AND APPARATUS FOR RESOURCE ALLOCATION OF AMBIENT INTERNET OF THINGS

(71) Applicant: Samsung Electronics Co., Ltd., Gyeonggi-do (KR)

(72) Inventors: Yaser Mohamed Mostafa Kamal FOUAD, San Diego, CA (US); Philippe Jean Marc Michel SARTORI, Naperville, IL (US); Youn Hyoung HEO, Sunnyvale, CA (US)

(21) Appl. No.: 19/000,983

(22) Filed: Dec. 24, 2024

Related U.S. Application Data
(60) Provisional application No. 63/615,154, filed on Dec. 27, 2023.

(51) Int. Cl. H04W 72/0453; H04B 7/22; H04W 28/20; H04W 48/10

(52) U.S. Cl. CPC H04W 72/0453; H04B 7/22; H04W 28/20; H04W 48/10

(57) ABSTRACT

An apparatus and a method are disclosed for resource allocation in ambient IoT systems. A method performed by a first device in an ambient IoT system includes activating as a cluster head for ambient IoT devices, in response to a first condition being met; transmitting a first energizing signal to the ambient IoT devices on a first carrier frequency; transmitting an advertisement signal to the ambient IoT devices; and receiving, from a first ambient IoT device among the ambient IoT devices, a first backscattered signal based on the first energizing signal and the advertisement signal.

### CROSS-REFERENCE TO RELATED APPLICATION

This application claims the priority benefit under 35 U.S.C. § 119(e) of U.S. Provisional Application No. 63/615,154, filed on Dec. 27, 2023, the disclosure of which is incorporated by reference in its entirety as if fully set forth herein.

### TECHNICAL FIELD

The disclosure generally relates to ambient Internet of things (IoT). More particularly, the subject matter disclosed herein relates to improvements to resource allocation in ambient IoT systems.

### SUMMARY

Ambient IoT refers to a class of connected IoT devices that harvest naturally available energy sources such as magnetic electric fields, light, thermal differential, kinetic energy, vibration, etc., for power. These sources, which may also be referred to as ambient sources of energy, can reduce dependency on—and potentially even replace the need for—batteries, leading to products with flexible form-factors, lower bill of materials (BOM) costs, and longer product lifetimes.

Ambient IoT systems are also expected to have lower complexity and cost when compared to their narrowband (NB) IoT counterparts, and are expected to provide a wide range of applications such as asset tracking and building health monitoring (i.e., applications that previously utilized radio frequency (RF) identification (ID) tags). The simplicity of such devices is at least partially due to the fact that they may be battery free in cases and thus are applicable in extreme environmental conditions. However, unlike RF ID systems, it is expected that ambient IoT devices will have a much higher communication range, improved reliability, and more advanced multiplexing, which is expected to allow for simultaneous communication with a relatively large number of ambient IoT devices from longer ranges. For example, in some cases, ambient IoT devices are expected to be able to communicate with a base station at ranges up to 500 meters.

Some possible applications of ambient IoT devices have been identified new radio (NR) Rel-18, and it is expected that ambient IoT systems design will be a major aspect of NR Rel-19.

The design of efficient resource allocation procedures will be important to realize gains of ambient IoT systems. That is, because such systems are expected to have massive numbers of low power/complexity devices that are attempting to communicate simultaneously or within a short time window, collisions will likely occur between the transmissions of such devices, rendering their communications unreliable. Hence, a need exists for resource selection/assignment procedures for ambient IoT systems.

Accordingly, an aspect of the disclosure is to provide a scheme in which resources may be scheduled by a base station, e.g., a gNB, directly or by an intermediate node (e.g., when resources are assigned by the gNB and relayed by the intermediate node).

Another aspect of the disclosure is to provide a scheme in which distributed resource allocation may utilized, wherein ambient IoT devices perform sensing or receive sensing information from a neighboring node, e.g., a gNB, and select their resources.

Another aspect of the disclosure is to provide a cluster-based approach for resource selection in ambient IoT systems.

Another aspect of the disclosure is to provide a scheme in which signaling may be used to trigger an intermediate node to act as a cluster head and send an energizing signal.

Another aspect of the disclosure is to provide a scheme in which signaling may be used to advertise for available cluster heads.

Another aspect of the disclosure is to provide a scheme in which signaling may be used by ambient IoT devices to join neighboring cluster heads.

Another aspect of the disclosure is provide a centralized scheduling technique for use by a gNB for advertisement/association messages.

Another aspect of the disclosure is provide a distributed technique that may be used by cluster heads for sensing an environment and accordingly selecting resources to be used for advertisement and association messages.

Another aspect of the disclosure is to provide a congestion control metric that may be used to determine a number of resources accessible by a cluster head and its associated ambient IoT devices.

Another aspect of the disclosure is to provide a scheme in which priority-based channel sensing may be performed before an ambient IoT device sends a transport block (TB) on a randomly selected resource.

Another aspect of the disclosure is to provide a scheme in which a dummy reservation signal may be transmitted by an ambient IoT device for channel reservation.

Another aspect of the disclosure is to provide a scheme in which a reader may schedule neighboring ambient IoT devices by using an energizing signal.

In accordance with an aspect of the disclosure, a relatively large number of ambient IoT devices may simultaneously communicate with low throughput to support ambient IoT applications.

In accordance with another aspect of the disclosure, chances of collisions may be reduced by reducing a number of ambient IoT devices attempting to communicate directly with a gNB.

In accordance with another aspect of the disclosure, a gNB may assign a cluster head role to UEs within a certain area to avoid triggering of too many cluster heads.

In accordance with another aspect of the disclosure, ambient IoT devices may identify neighboring cluster heads and accordingly decide on which cluster head to join.

In accordance with another aspect of the disclosure, ambient IoT devices can efficiently signal their associations with neighboring cluster heads.

In accordance with another aspect of the disclosure, chances of collisions between transmissions of neighboring clusters may be reduced.

In accordance with another aspect of the disclosure, a cluster head may independently select resources for transmissions based on localized channel sensing.

In accordance with another aspect of the disclosure, chances of collisions between neighboring ambient IoT devices may be reduced by introducing congestion control regulations on transmissions.

In accordance with another aspect of the disclosure, chances of collisions between ambient IoT device transmissions may be reduced while prioritizing transmissions from a subset of ambient IoT devices with a priority satisfying a threshold.

In accordance with another aspect of the disclosure, dummy reservation signals can be distinguished from regular ambient IoT transmissions by using a different modulation scheme or a pre-configured pattern.

In accordance with another aspect of the disclosure, signaling overhead to indicate accessible resources by neighboring ambient IoT devices may be reduced by using an energizing signal.

In an embodiment, a method performed by a first device in an ambient IoT system includes activating as a cluster head for ambient IoT devices, in response to a first condition being met; transmitting a first energizing signal to the ambient IoT devices on a first carrier frequency; transmitting an advertisement signal to the ambient IoT devices; and receiving, from a first ambient IoT device among the ambient IoT devices, a first backscattered signal based on the first energizing signal and the advertisement signal.

In an embodiment, a first device operable in an ambient IoT system includes a transceiver; and a processor configured to activate the first device as a cluster head for ambient IoT devices, in response to a first condition being met, transmit, via the transceiver, a first energizing signal to the ambient IoT devices on a first carrier frequency, transmit, via the transceiver, an advertisement signal to the ambient IoT devices, and receive, from a first ambient IoT device among the ambient IoT devices, a first backscattered signal based on the first energizing signal and the advertisement signal.

### BRIEF DESCRIPTION OF THE DRAWING

In the following section, the aspects of the subject matter disclosed herein will be described with reference to exemplary embodiments illustrated in the figures, in which:

FIG. 1 illustrates an example of ambient IoT topology 1;

FIG. 2 illustrates an example of ambient IoT topology 2;

FIG. 3 illustrates an example of ambient IoT topology 3 with downlink assistance;

FIG. 4 illustrates an example of ambient IoT topology 3 with uplink assistance;

FIG. 5 illustrates an example of ambient IoT topology 4;

FIG. 6 illustrates examples of ambient IoT clusters with a UE and a gNB acting as cluster heads, according to an embodiment;

FIG. 7 illustrates an example of a gNB using DCI triggering of a cluster head to send an advertisement message, according to an embodiment;

FIG. 8 illustrates an association confirmation indicated to a cluster head through backscattering, according to an embodiment;

FIG. 9 illustrates multiple energizing signals being used for frequency multiplexing of backscattered messages from multiple ambient IoT devices, according to an embodiment;

FIG. 10 illustrates frequency multiplexing of multiple ambient IoT devices through random up/down conversion of a received energizing signal, according to an embodiment;

FIG. 11 illustrates an example of collision avoidance between ambient IoT devices through a random backoff duration, according to an embodiment;

FIG. 12 illustrates an example of collision avoidance between ambient IoT devices through energy detection, according to an embodiment;

FIG. 13 illustrates an example of Type-C devices sending association confirmations after an energizing signal is stopped, according to an embodiment;

FIG. 14 illustrates an example of a gNB scheduling of an advertisement message and resources for association messages, according to an embodiment;

FIG. 15 illustrates an example of a cluster head triggering of channel busy ratio (CBR) measurements, according to an embodiment.

FIG. 16 is signal flow diagram illustrating an ambient IoT data harvesting procedure by a cluster head, according to an embodiment;

FIG. 17 is a flowchart illustrating a clustering procedure for ambient IoT devices, according to an embodiment;

FIG. 18 illustrates a sensing window of a resource selection for backscattering by ambient IoT devices, according to an embodiment;

FIG. 19 is a flow chart illustrating a random access procedure for an ambient IoT system based on energy detection, according to an embodiment;

FIG. 20 illustrates an example of a channel reservation signal being used to occupy a channel before a slot boundary, according to an embodiment;

FIG. 21 is a flow chart illustrating a method performed by a cluster head device, according to an embodiment;

FIG. 22 is a block diagram of an electronic device in a network environment, according to an embodiment.

FIG. 23 shows a system including an ambient IoT device, a UE, and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purposes only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

### Ambient IoT Device Categories

In ambient IoT systems, it is expected that a relatively large number of devices will be deployed. Hence, these devices are expected to be much cheaper than NB-IoT devices and thus are order(s) of magnitude simpler than their NB-IoT counterparts. For example, the 3^{rd} generation partnership project (3GPP) has categorized ambient IoT devices based on their energy storage capacity and their capability of generating RF signals for transmissions in to the following three categories:

Device Type A: No energy storage, no independent signal generation/amplification, i.e., backscattering transmission. For example, Device Type A simply reflects signals back to the direction they came from.

Device Type B: Has energy storage, no independent signal generation, i.e., backscattering transmission. Use of stored energy can include amplification for reflected signals.

Device Type C: Has energy storage, has independent signal generation, i.e., active RF components for transmission.

For all device types (i.e., A, B and C), the expectation is that they are able to demodulate control and data from an entity in a radio access network (RAN), e.g., a user equipment (UE) or a gNB, according to underlying topology.

### Ambient IoT Topologies

As ambient IoT devices are expected to operate in different environments (e.g., outdoor and indoor) and to support a wide range of communication distances (e.g., large distances for outdoor and small distances for indoor applications), 3GPP has also introduced topologies (i.e., topologies 1 through 4) to allow ambient IoT devices to communicate with a network.

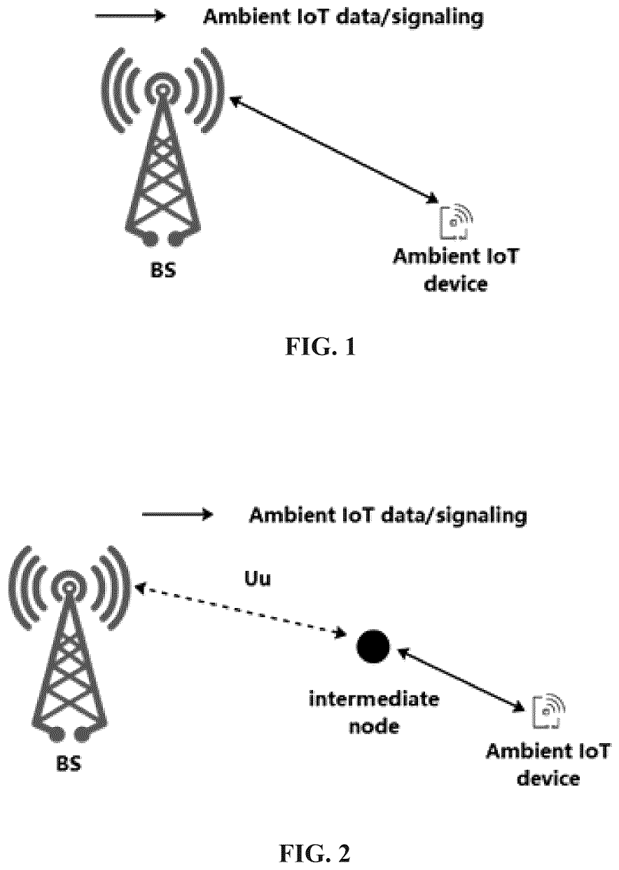

FIG. 1 illustrates an example of ambient IoT topology 1.

Referring to FIG. 1, in topology 1, an ambient IoT device directly communicates with a base station. This communication may be bidirectional with no assistance node in between. In addition, the ambient IoT device can receive from one base station and respond to another base station.

FIG. 2 illustrates an example of ambient IoT topology 2.

Referring to FIG. 2, in topology 2, an intermediate node (e.g., a relay, an integrated access and backhaul (IAB) node, a UE, a repeater, etc.) is provided to facilitate communication between an ambient IoT device and a base station. The communication between the ambient IoT device and the intermediate device may be bidirectional.

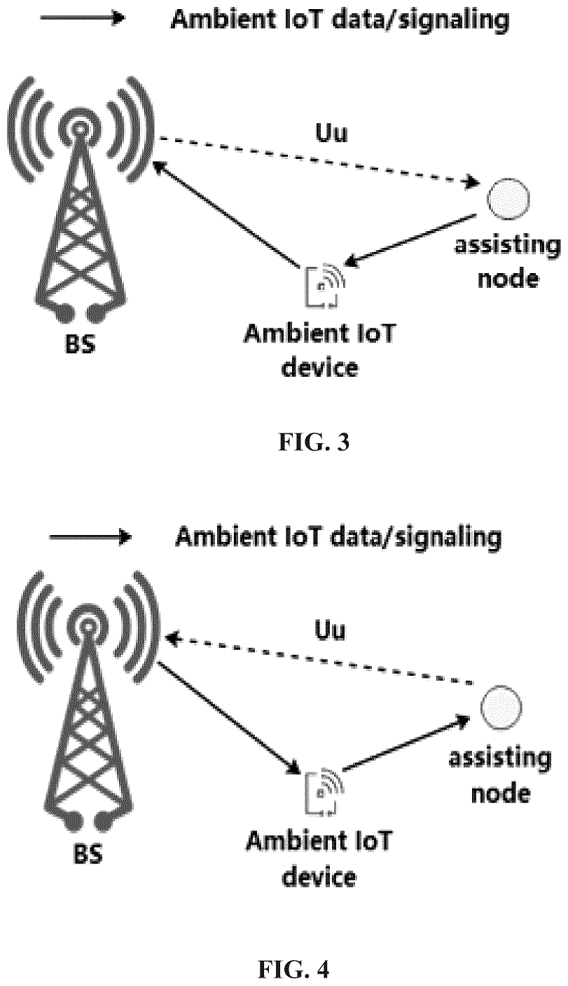

FIG. 3 illustrates an example of ambient IoT topology 3 with downlink assistance, and FIG. 4 illustrates an example of ambient IoT topology 3 with uplink assistance.

Referring to FIGs, 3 and 4, in topology 3, similar to topology 2, there is an intermediate node that facilitates communication between an ambient IoT device and a base station. However, in topology 3, communication with the assisting node is not bidirectional.

For example, in case of topology 3 with downlink assistance, as illustrated in FIG. 3, the ambient IoT device transmits uplink communication directly to the base station while receiving only downlink communication through the intermediate node.

In case of topology 3 with uplink assistance, as illustrated in FIG. 4, the ambient IoT device receives downlink communication directly from the base station while sending only uplink communication through the intermediate node.

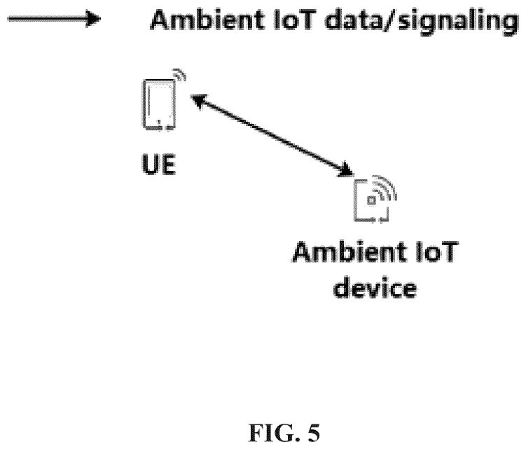

FIG. 5 illustrates an example of ambient IoT topology 4.

Referring to FIG. 5, in topology, 4 there is no base station involvement and the communication is bidirectional between an ambient IoT device and a nearby UE.

In ambient IoT systems, e.g., based on the topologies above, it is expected that a relatively large number of devices may try to communicate with a source at any given instance, which can result in collisions between transmissions of neighboring ambient IoT devices, thus affecting the system performance.

To address these types of drawbacks, accordingly to embodiment of the disclosure, clusters may be utilized. More specifically, intermediate nodes/UEs can act as cluster heads and accordingly schedule transmissions of associated ambient IoT devices in order to reduce the chances of collisions.

In addition, cluster heads can also aggregate transmissions of multiple ambient IoT devices in order to reduce the number of transmissions being sent to a source (e.g., a gNB).

According to another embodiment of the disclosure, random resource selections with energy detection and random back offs can be utilized. More specifically, ambient IoT devices may perform energy detection and transmit their scattered signals if a channel is detected as being unoccupied. This may reduce the chances of collisions between the transmissions of neighboring ambient IoT devices.

In addition, ambient IoT devices can also apply random backoffs before performing backscattered transmissions to avoid collisions with neighbor transmissions.

### Cluster Based Resource Allocation

In ambient IoT systems, devices are expected to have limited energy storage capabilities or even no batteries at all. Therefore, unlike sidelink transmissions, these devices may not be able to sense their environments and accordingly identify resources occupied by neighbors for collision avoidance. More specifically, sensing an environment to identify future occupied resources and accordingly avoid them may require a relatively large amount of energy (e.g., similar to sidelink Mode 2 sensing), which is not likely possible for Type A devices and Type B devices in the absence of an energizing signal, and/or for Type C devices, which have limited energy storage.

To address this type of drawback, according to an embodiment, cluster-based resource allocation may be utilized. In cluster-based resource allocation, each cluster may include a set of ambient IoT devices and their resources can be scheduled by a cluster head. In this case, the cluster head can be either an intermediate node or a UE, or an ambient IoT Type C device. For example, Type C devices are expected to have an onboard battery and thus can perform some sensing before performing a transmission.

The following description of certain embodiments of the disclosure describe examples in which cluster heads are neighboring UEs. However, embodiments of the disclosure are not limited to these examples, e.g., a cluster head may also be a gNB.

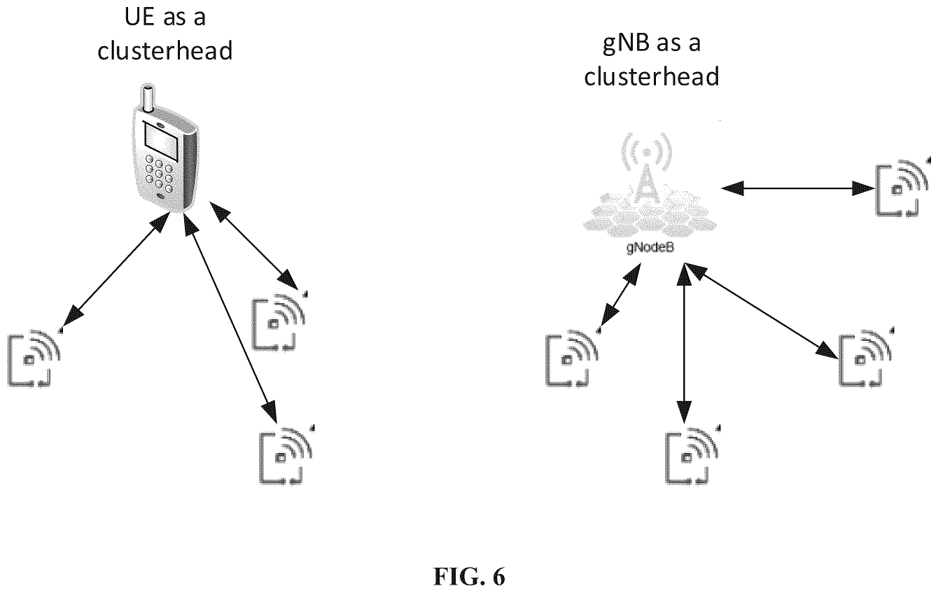

FIG. 6 illustrates examples of ambient IoT clusters with a UE and a gNB acting as cluster heads, according to an embodiment.

Referring to FIG. 6, to form a cluster, a UE may perform a sidelink transmission to advertise its presence and its ability to form a cluster. When in coverage, activation, i.e., the designation to act as a cluster head, can be triggered by a gNB through downlink control information (DCI) signaling (e.g., a new DCI format or an existing DCI format with a new field indicating the triggering of the UE to act as a cluster head).

Alternatively, a cluster head can be triggered by a gNB through (pre)-configuration or radio resource control (RRC) signaling since the cluster head is expected to operate for relatively long durations.

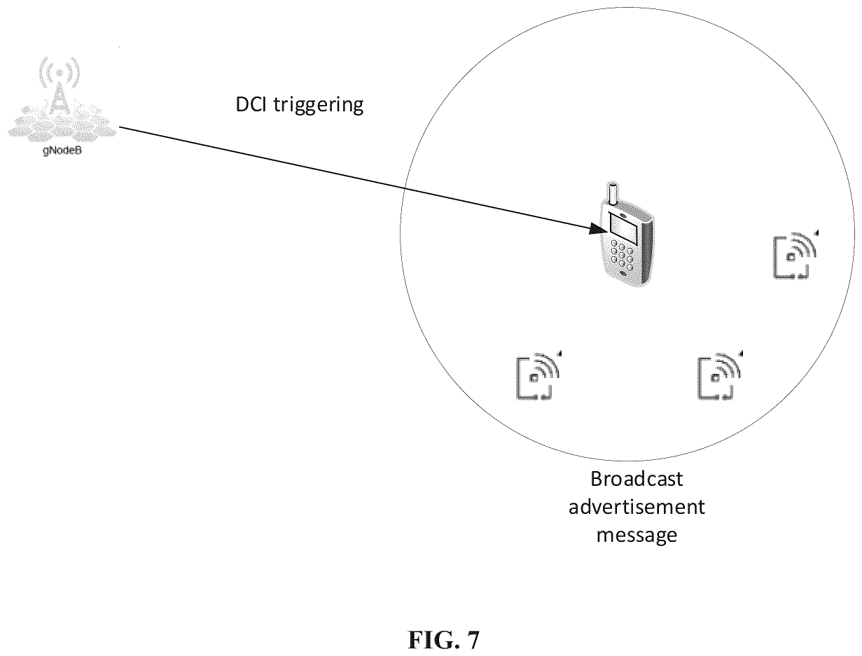

FIG. 7 illustrates an example of a gNB using DCI triggering of a cluster head to send an advertisement message, according to an embodiment.

Referring to FIG. 7, the gNB transmits DCI to a UE, where the DCI includes a triggering indication that triggers the UE to broadcast an advertisement message for ambient IoT devices. The triggering indication can be multiplexed with resources to be used for sending the advertisement message.

Alternatively, in out of coverage scenarios, a UE can autonomously be triggered to act as a cluster head or be triggered when a transmission is detected from a neighboring ambient IoT device. This triggering mechanism can be enabled/disabled by (pre)-configuration. For example, if a neighboring cluster head is detected with a received power (e.g., a reference signal received power (RSRP) measured on an energizing signal used to active the ambient IoT devices or control/data signals) above a (pre)-configured threshold, a UE may refrain from becoming a cluster head to avoid collisions.

In accordance with the above described embodiments, a UE or an intermediate node can be triggered to act as a cluster head for resource allocation of neighboring ambient IoT devices. A new DCI format or an existing DCI format with a new field can be used by a gNB to trigger an intermediate node (e.g., a UE) to act as a cluster head. The DCI can also allocate resources for an advertisement message.

If (pre)-configured and enabled, a UE can be autonomously triggered to act as a cluster head or when neighboring ambient IoT devices are detected.

A UE can also refrain from acting as a cluster head if a neighboring cluster head is detected with received power (e.g., RSRP) above a pre-configured threshold.

After being triggered to be a cluster head, a UE may send an energizing signal to activate neighboring ambient IoT devices, followed by control signaling, e.g., an advertising signal, and an optional payload. The control signaling can indicate the presence of the cluster head, its ID, and its capabilities (e.g., sensing capabilities, target UE ID, etc.) as well as whether or not it is connected to the gNB. The following payload can also carry a medium access control (MAC) control element (CE) indicating some additional control information such as target ambient IoT device ID(s) or a duration of cluster head association.

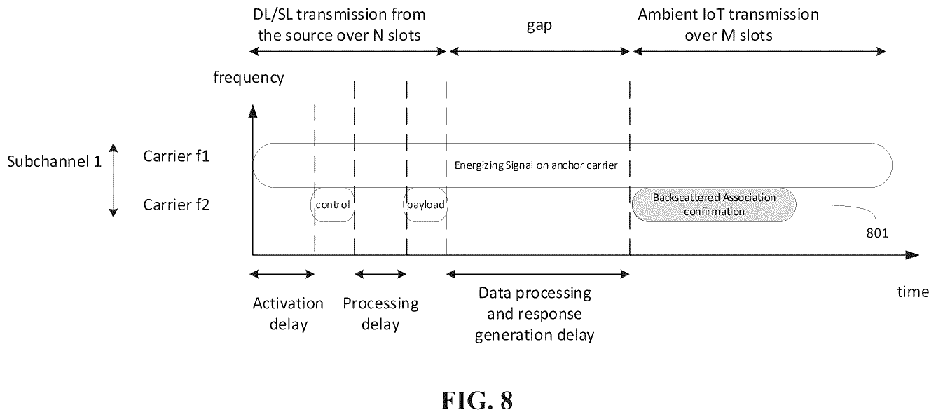

FIG. 8 illustrates an association confirmation indicated to a cluster head through backscattering, according to an embodiment.

Referring to FIG. 8, after ambient IoT devices receive broadcasted cluster head messages, they should respond, e.g., send an acknowledgement/negative acknowledgment (ACK/NACK) message to confirm their association). This ACK/NACK message can be sent through backscattering 801 of the received energizing signal from the UE.

However, since a relatively large number of ambient IoT devices are expected to respond simultaneously, it is likely that their messages will collide. To address this type of issue, according to an embodiment, a multi-channel approach may be utilized, wherein ambient IoT device transmissions are multiplexed in time and frequency.

To select the resources with minimal collisions, one or more of the following approaches may be utilized:

### Multiple Energizing Signals (Frequency Multiplexing):

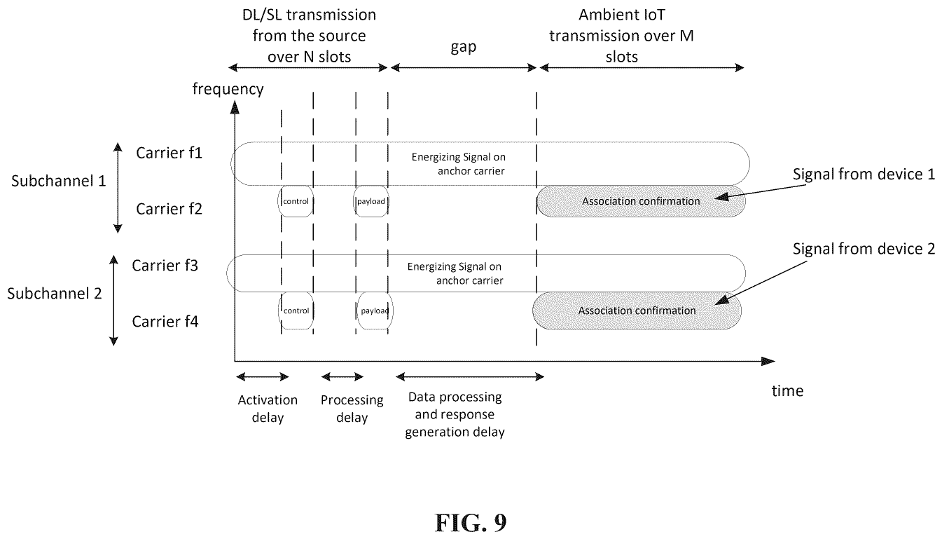

FIG. 9 illustrates multiple energizing signals being used for frequency multiplexing of backscattered messages from multiple ambient IoT devices, according to an embodiment.

Referring to FIG. 9, a UE can send multiple energizing signals over multiple carriers. Subsequently, ambient IoT devices can randomly select one of the transmitted energizing signals and perform backscattering. This approach may be helpful when ambient IoT device capabilities are limited and an ambient IoT device is not able to perform up/down conversion of the received energizing signal. In this type of approach, control signaling from a source can be repeated in each energizing signal or not based on a resource pool (pre)-configuration. In particular, if the control signaling is repeated, power will be wasted, but this reduces the complexity of the ambient IoT devices since they will only monitor a subset of the bandwidth on which they are expected to respond. On the other hand, sending control signaling only once in a subchannel will save power but would require ambient IoT devices to perform reception on a subchannel and backscattering on a different subchannel based on a randomly selected backscattering energizing signal.

### Random Up/Down Conversion (Frequency Multiplexing):

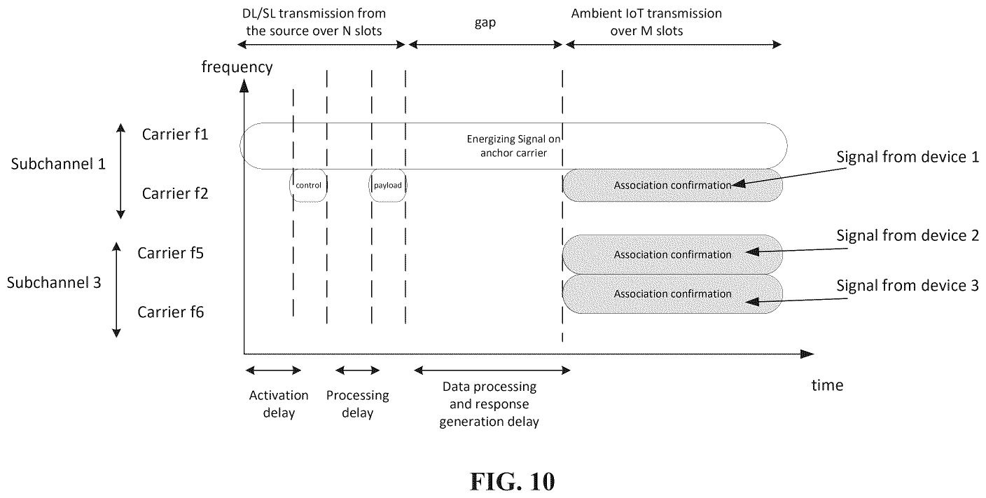

FIG. 10 illustrates frequency multiplexing of multiple ambient IoT devices through random up/down conversion of a received energizing signal, according to an embodiment.

Referring to FIG. 10, after receiving an energizing signal, each ambient IoT device can perform backscattering based on the received energizing signal. However, each of the ambient IoT devices should also randomly select an up/down conversion offset to apply to the received energizing signal in order to avoid collisions with neighboring devices.

As illustrated in FIG. 10, ambient IoT devices 1, 2, and 3, each transmit an association confirmation at different carrier frequencies. Random backoff (time multiplexing):

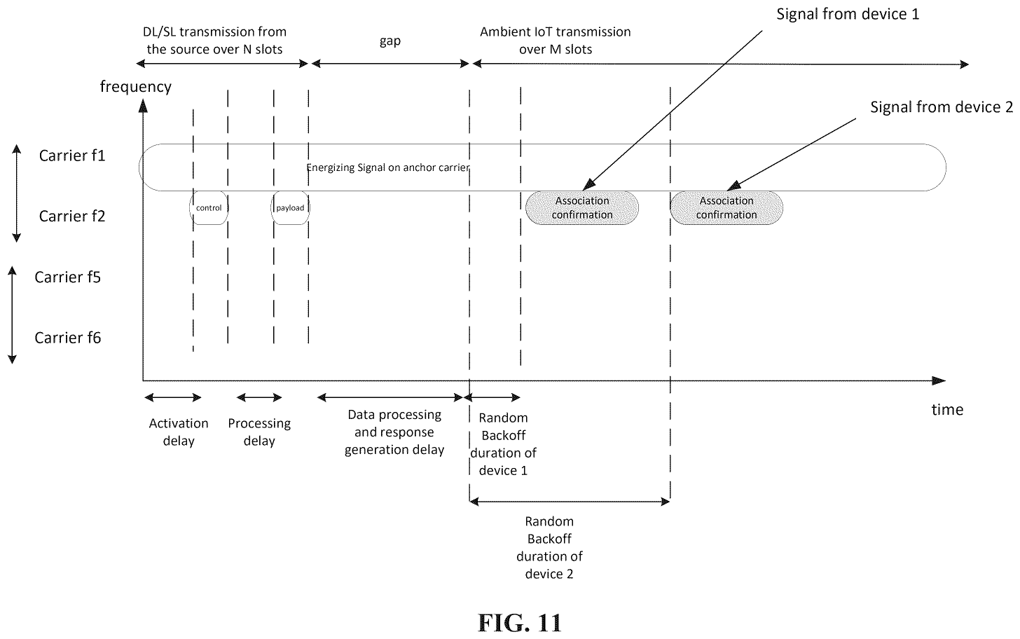

FIG. 11 illustrates an example of collision avoidance between ambient IoT devices through a random backoff duration, according to an embodiment.

Referring to FIG. 11, in performing a random backoff, after receiving the energizing signal, each ambient IoT device applies a random backoff duration before performing the backscattering to send a confirmation message to a cluster head. As illustrated in FIG. 11, ambient IoT devices 1 and 2, each transmit an association confirmation at different times, based on different random backoff durations.

The duration of a random backoff can be dependent on a device priority. For example, each ambient IoT device can randomly select a value from a window and adjust its transmission counter to this value. Subsequently, an ambient IoT device does not perform a transmission until its transmission counter is equal to zero. The duration of this window may depend on device priority. These values can be standardized or can be (pre)-configured per resource pool.

A random backoff duration can also be dependent on a device ID (e.g., by applying a hash function on the device ID).

### Sensing-Based Approach:

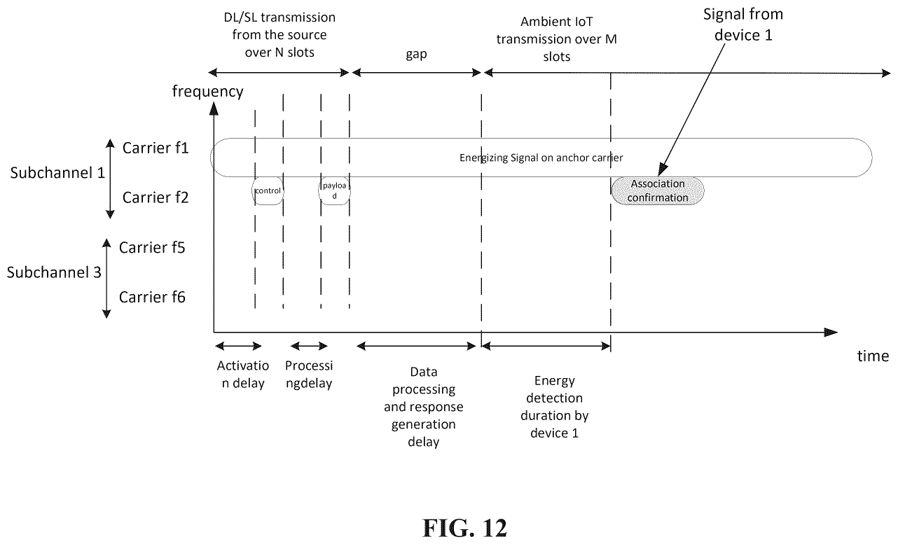

FIG. 12 illustrates an example of collision avoidance between ambient IoT devices through energy detection, according to an embodiment.

Referring to FIG. 12, in a sensing based approach, an ambient IoT device that is expecting to send a backscattering message on a carrier X may perform energy detection on this carrier to identify its occupancy. Subsequently, if carrier X is identified as being empty (e.g., received energy is below a pre-configured threshold per resource pool) for a given duration, the ambient IoT device can proceed to occupy the carrier X and perform its backscattered transmission to reach a cluster head. The energy detection duration for an ambient IoT device may be based on priority or randomly selected from one or multiple windows (e.g., a smaller window can be (pre)-configured for higher priority transmissions).

### Device Type:

According to an embodiment, a cluster head can indicate, e.g., in a control message, an association between an ambient IoT device type and a carrier over which to send a backscattered signal. In this case, each ambient IoT device can perform an up/down conversion according to its device type before sending a confirmation message. In such a case, a lowest device category (e.g., a Type A device) may be expected to perform the least amount of up/down conversions when compared to other device types (e.g., a Type B device).

### ID-Based Approach:

According to an embodiment, a cluster head can indicate, e.g., in a control message, an association between an ambient IoT device ID and a carrier over which to send a backscattered signal. In this case, each ambient IoT device can perform an up/down conversion according to its device type before sending a confirmation message. For example, a smaller number of bits can be allocated to a target device ID in a control message, and thus, a hash function may be applied to perform a match.

According to an embodiment, an advertisement message indicating a presence of a cluster head may include one or more of the following in control/data portions:

Cluster head ID: In some cases, an ambient IoT device can select a specific cluster head. For instance, in case of an indoor application, ambient IoT devices may connect to a designated cluster head and not a neighboring apartment cluster head. However, if it is open/public cluster head, this could be omitted.

Targeted ambient IoT device(s) IDs: For an indoor application with asset tracking, there may be a need to connect only to specific ambient IoT devices and not neighboring devices in general. In this case, a cluster head may trigger reporting from only the interested ambient IoT devices through IDs, which may be unicast IDs or a groupcast ID.

Sensing capabilities: The ability to detect neighboring reservations and accordingly avoid collisions can differ between a UE and Type C ambient IoT devices. For example, if two devices are acting as cluster heads, it is likely better to join the device with better sensing capabilities.

Connectivity to a gNB: A cluster head can indicate whether it is in-coverage or out-of-coverage. In addition, the cluster head can also indicate whether a resource is scheduled by the gNB. For example, if a resource is reserved by the gNB, chances of a collision will be less and it may have better synchronization, and thus it may be more lucrative to join the cluster head.

In accordance with the above-described embodiments, ambient IoT devices can send an ACK/NACK message through backscattering of a received energizing signal to confirm their association with a cluster head.

Additionally, collisions between backscattering association messages from the ambient IoT devices can be avoided through:
the use of multiple energizing signals with different carrier frequencies;
ambient IoT devices performing random or device-type based up/down conversions of a received energizing carrier;
performing random back off before sending an association message;
using an indicated carrier based on a device ID; or
performing energy detection before transmitting an association message.

To ensure that a response message is correctly received by a cluster head, an ambient IoT device can perform multiple repetitions in time or frequency. The number of repetitions can be (pre)-configured per resource pool and/or can be dependent on device priority.

In addition, a separation between repetitions in time and/or frequency can be dependent on device priority and/or can be randomly selected from a window. For example, if a resource pool configuration indicates two repetitions that are separated in time, then an ambient IoT device can select to transmit its backscattered signal on carrier Z at time slots y₁ and y₁+N, where N is a random number that is selected from a window (e.g., the duration of this window can be dependent on a device type and its priority). However, all repetitions by device Types A and B are expected to occur within an energizing signal window such that they are able to perform backscattering.

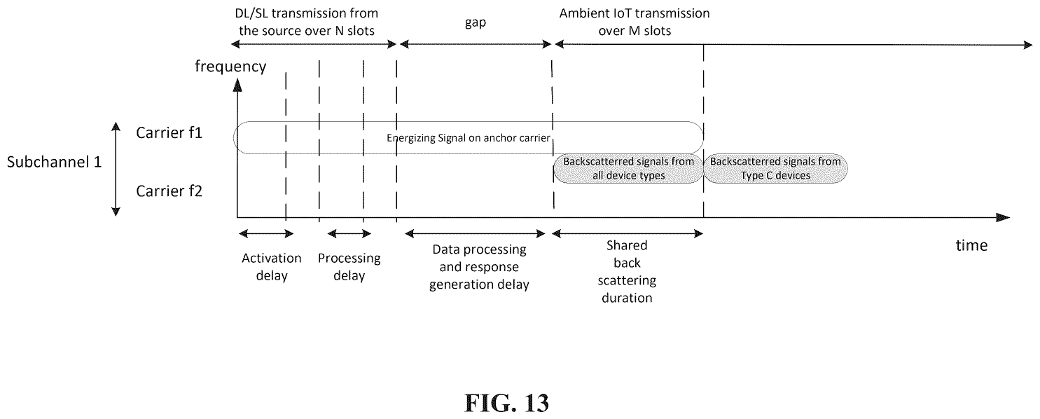

FIG. 13 illustrates an example of Type-C devices sending association confirmations after an energizing signal is stopped, according to an embodiment.

Referring to FIG. 13, in some cases, to reduce the chance of collision, Type C devices may elect to perform one or more repetitions after an energizing signal window is stopped (e.g., by applying a delay after the end of a last symbol in which an energizing signal is transmitted). Once the energizing signal is stopped, Type A and Type B devices will not be able to perform backscattering and thus the chance of collision is reduced.

To reduce latency and ensure energy efficiency, a cluster head may consider a window in which it is expected to receive a confirmation signal to indicate an association between an ambient IoT device and the cluster head. The duration of this window can be (pre)-configured per resource pool, selected randomly by the cluster head, or history based, depending on the number of ambient IoT devices that responded in a previous window and the number of ambient IoT devices currently active within the cluster head. For example, the larger the number of ambient IoT devices expected, the larger the window is expected.

In order to reduce collisions between response messages of Type C devices and other device types (i.e., Types A and B devices, which rely on the presence of an energizing signal), a cluster head may refrain from transmitting the energizing signal for a whole window duration.

In accordance with the above-described embodiments, to improve reliability, ambient IoT devices can send multiple acknowledgement messages to a cluster head. The number of these repetitions can be (pre)-configured per resource pool.

Additionally, a time separation between consecutive repetitions can be either (pre)-configured or selected randomly from time windows that are (pre)-configured based on device priority.

Further, to reduce collisions, ambient IoT Type C devices can send their acknowledgement messages after the energizing signal is stopped.

Another aspect of the disclosure is to provide a method for scheduling an advertisement message and associated resources for confirmation messages from ambient IoT devices.

According to an embodiment, this can be done by receiving DCI from a gNB scheduling a set of resources to a designated cluster head.

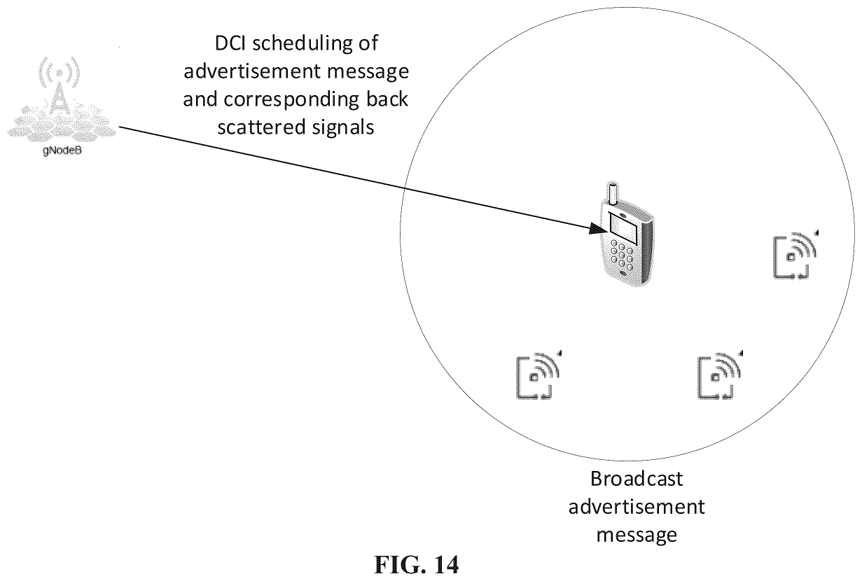

FIG. 14 illustrates an example of a gNB scheduling of an advertisement message and resources for association messages, according to an embodiment.

Referring to FIG. 14, the gNB can schedule enough resources for an advertisement message as well as resources over which the ambient IoT devices are expected to respond.

Alternatively, a cluster head can select resources to transmit by performing sensing and resource reservation. In particular, a cluster head can perform sensing to identify future reservations performed by neighboring UEs (i.e., by decoding the future reservations indicated by the neighboring ambient IoT devices in their 1st or 2nd stage sidelink control information (SCI) or in a MAC CE).

After the cluster head identifies that a set of resources are available, it can randomly select one of the available resources to send its advertisement message as well as to receive feedback from ambient IoT devices. A reservation performed by the cluster head can cover multiple consecutive slots. The number of these slots can be indicated in SCI or as a MAC CE (e.g., similar to the case of sidelink transmissions).

Resources used for an advertisement message and resources used for confirmation messages may not necessarily come from the same resource pool. For example, two or more resources pools can be (pre)-configured, such that one resource pool is used to send advertisement messages and the remaining resource pools are used to receive response messages.

After forming a cluster, the cluster head can schedule transmissions from neighboring ambient IoT devices. The cluster head may also perform resource reservations on behalf of the cluster members and pass the reservation information to the neighboring ambient IoT devices. In addition, the cluster head may collect all of the transmissions from the neighboring ambient IoT devices before forwarding them to a gNB.

To perform these operations, a cluster head may utilize resource reservation, indication of reserved resources to neighboring ambient IoT devices (triggering), location aware scheduling, assisted resource scheduling, and/or combining and retransmitting received messages from ambient IoT devices, as will be described below in more detail.

### Resource Reservation:

To perform a resource reservation for either itself or a cluster member, a cluster head can perform sensing to identify resources reserved by neighbors. In particular, the cluster head may establish a sensing window and a resource selection window. In the sensing window, the cluster head receives reservations of future resources for its neighbors and accordingly excludes the reserved resources from a set of candidate resources in the resource selection window. Subsequently, the candidate resources in the resource selection window are then passed to a higher layer, which may randomly select a resource.

A reservation from neighboring UEs can be sent in SCI to be detected by the cluster head. For example, a reservation can be in 1st or 2nd stage SCI if a 2 step approach is considered, similar to that of a sidelink.

A reservation from neighboring cluster heads can also be sent as a MAC CE. In addition, resource candidates within the resource selection window may include multi-slots in order to allow enough time for the cluster head and ambient IoT devices to perform their transmissions and pass their payloads.

Since ambient IoT transmissions may be aperiodic, a cluster head should be able to perform contiguous sensing for a duration equal to a maximum resource reservation range, subject to processing requirements, in order to be able to detect all of the reservations of neighboring cluster heads. In particular, if a resource selection window starts from slot n, the cluster head should perform sensing between n−T₀ and n−T_{proc}, where T₀ is the maximum future slot reservation indication (e.g., in the SCI or in the MAC CE) and T_{proc} is the processing time required for the received reservation and transport block (TB) preparation.

Alternatively, the cluster head can send a resource reservation request to the gNB based on the number of associated ambient IoT devices. Subsequently, the gNB can send DCI to schedule transmissions from the cluster head and its neighboring ambient IoT devices. Thereafter, the cluster head may schedule the transmissions of the ambient IoT devices within its cluster.

### Indication of Reserved Resources to the Neighboring Ambient IoT Devices (Triggering):

A cluster head can send an energizing signal to activate neighboring ambient IoT devices. Thereafter, the cluster head can send control signaling to trigger the neighboring ambient IoT devices and to indicate resource allocations, e.g., by associating each device ID with a resource (e.g., a carrier and a time slot). The cluster head can also use a hashed device ID to reduce signaling overhead when performing resource allocation.

Time and frequency resources can be indicated using two fields. In particular, one or more time resource indication value (TRIV) fields can be used to indicate the assignment of one or more slots within the signaling window. In addition, one or more frequency resource indication value (FRIV) fields can be used to indicate one or more carrier frequencies to be used in the future transmissions. Furthermore, a new field (e.g., a one bit field) can be added to indicate whether an ambient IoT Type C device may rely on backscattering or perform transmission based on its internally generated signal. This can help in freeing backscattering resources for the less capable Type A or Type B devices.

Control signaling can carry multiple assignments in one transmissions (i.e., multiple device IDs and the associated time and frequency allocations).

Subsequently, a cluster head can maintain an energizing signal to allow for backscattering if Type A and B devices are scheduled or stop the energizing signal if a Type C device is scheduled for transmission.

Alternatively, the cluster head can send scheduling information without an energizing signal if a Type C device is scheduled and if it does not have a wake-up radio (i.e., if the Type C device is able to detect the scheduling information from the cluster head without an energizing signal).

Groupcast or broadcast based triggering can also be considered, wherein a cluster head can indicate to all or a subset of neighboring ambient IoT devices to perform a backscattered or an internally generated transmission. For example, this can be done by including a groupcast ID or a reserved broadcast ID in control signaling from the cluster head. It can also be implicitly indicated by sending an energizing signal on a specific (pre)-configured carrier frequency that is monitored by a subset or all ambient IoT devices. In this case, all of the neighboring ambient IoT devices that detect a received power above a (pre)-configured threshold on this carrier frequency are expected to be triggered.

Multiple pre-configured carriers can be used to trigger multiple ambient IoT Type devices. For example, sending an energizing signal on carrier f₁ can indicate broadcast triggering of all Type A or Type B UEs, whereas sending an energizing signal on carrier f₂ can indicate broadcast triggering of all Type C UEs. In addition, a chosen carrier frequency of the energizing signal can also indicate whether an ambient IoT Type C device is expected to perform backscattering or to rely on an internally generated signal.

### Location Aware Scheduling:

Scheduling by a cluster head can consider a proximity with assisted ambient IoT devices within a cluster in order to avoid a hidden node problem. More specifically, when a relatively large number of ambient IoT devices, e.g., 5000 devices in a 50 m range or 200 devices in a 10 m range, are expected to be scheduled for transmission (e.g., by using groupcast or broadcast triggering in an area with a large number of devices) the cluster head can control the number of ambient IoT devices performing simultaneous transmission to avoid collisions. For example, groupcast or broadcast triggering can be targeted based on priority, wherein using a pre-configured frequency f₁ can trigger transmissions from UEs with priority P₁, whereas transmitting the energizing signal on a pre-configured frequency f₂ can trigger transmissions from UEs with priority P₂.

Additionally, locations of the neighboring ambient IoT devices may be obtained by considering a beam sweeping approach.

### Assisted Resource Scheduling:

Ambient IoT devices can perform simple sensing and accordingly provide some assistance information to a cluster head. For example, ambient IoT devices can perform energy detection on one or more carrier frequencies and accordingly perform a CBR measurement, which is basically a number of channel/slot resources with a measured RSRP above a (pre)-configured threshold (e.g., this threshold can be priority based) to a total number of channel/slot resources within a pre-defined duration. This measurement can then be transmitted to the cluster head to assist in resource scheduling. For example, if a measured CBR is below a (pre)-configured priority-based threshold, an ambient IoT device can be allowed to perform a transmission, whereas if the measured CBR is above the (pre)-configured priority-based threshold, the ambient IoT device can be prevented from performing the transmission.

In addition, a CBR measurement can also have an impact on a transmit power. For example, a transmit power of an ambient IoT device can be reduced (e.g., no amplification is allowed) if a measured CBR is above a (pre)-configured threshold. This power amplification threshold can be priority based, wherein only high priority transmission may be allowed to perform amplification if the CBR is high.

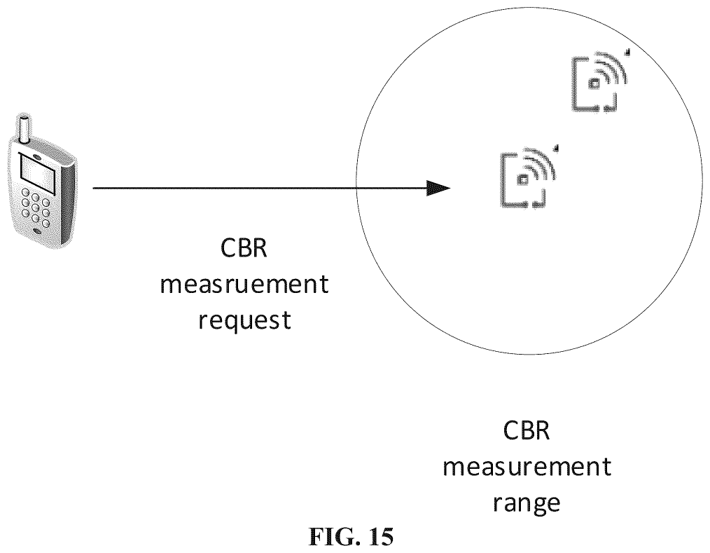

FIG. 15 illustrates an example of a cluster head triggering of CBR measurements, according to an embodiment.

Referring to FIG. 15, this triggering can be explicit by using a field (e.g., a one-bit field) in control signaling or a MAC CE or can be implicit by sending an energizing signal on a (pre)-configured carrier or by using a certain pattern for the energizing signal (e.g., an on-off signaling pattern).

In addition, CBR measurements can also be (pre)-configured per resource pool to be performed when an energizing signal is present and an ambient IoT device is in a receiving mode (i.e., not triggered to perform a transmission).

A CBR measurement can also be confined to carriers over which backscattering is allowed based on a resource pool (pre)-configuration or on all the carriers used by the ambient IoT devices for their transmissions. This can be considered when some carriers are dedicated for backscattering and others are dedicated for signals internally generated by the ambient IoT device based on a resource pool (pre)-configuration.

Combining and Retransmitting Received Messages from Ambient IoT Devices:

To reduce signaling overhead, a cluster head, e.g., a UE, can collect messages from a number of neighboring ambient IoT devices and then process them locally. In this case, multiple transmissions from the neighboring ambient IoT devices can be combined into a single message. For example, the IDs from 10 ambient IoT devices can be combined into a single message for asset tracking to reduce overhead. This combining can be enabled/disabled by a resource pool (pre)-configuration and can be indicated in control signaling. For example, a one-bit field can be added in control signaling from a cluster head to indicate to the neighboring ambient IoT devices whose messages will be combined. The indication can direct the ambient IoT devices to use a (pre)-configured security key to enable local processing at the cluster head. Similarly, the indication can be included from the ambient IoT device side to indicate that the transmitted message can be combined at the cluster head (e.g., indicating that a (pre)-configured security key is used).

Alternatively, a combining indication can be carried as a MAC CE in a payload.

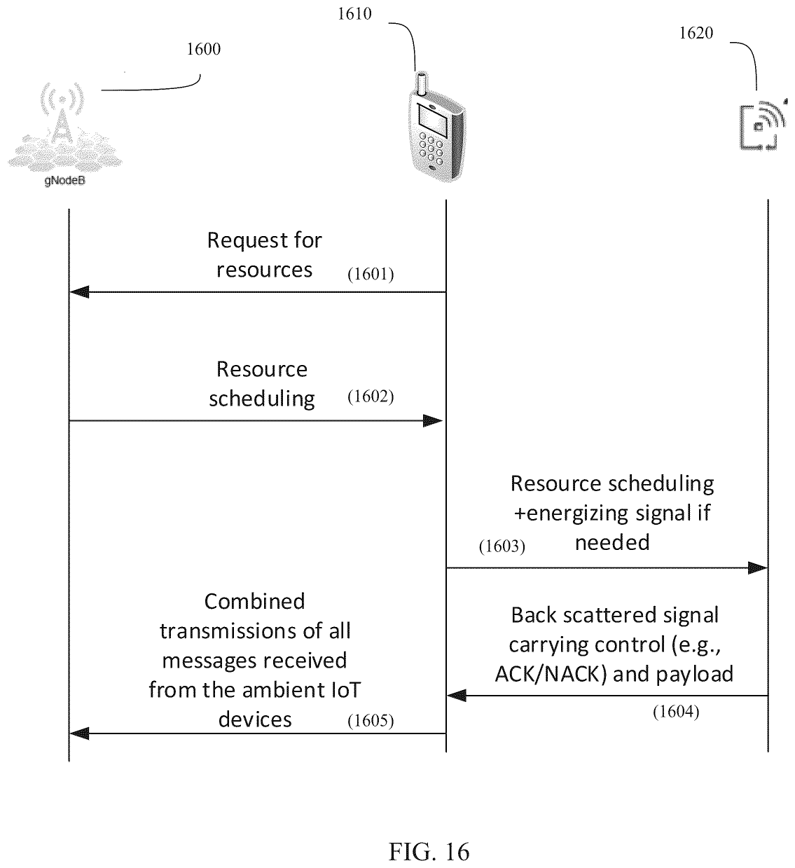

FIG. 16 is signal flow diagram illustrating an ambient IoT data harvesting procedure by a cluster head, according to an embodiment. More specifically, FIG. 16 illustrates operations in which resources are scheduled by a gNB.

Referring to FIG. 16, in step 1601, a cluster 1610, e.g., a UE, sends a request for resources to a gNB 1600.

In step 1602, in response to the request for resources, the gNB 1600 schedules resources and provides the scheduled resources to the cluster head 1610. For example, the gNB 1600 transmits DCI to the cluster head 1610, scheduling a set of resources.

In step 1603, the cluster head 1610 schedules resources and provides the scheduled resources to the cluster head 1610 along with an energizing signal, if necessary. For example, as described above, the cluster head 1600 can send an energizing signal to activate the neighboring ambient IoT devices 1620, and can send control signaling to trigger the neighboring ambient IoT devices 1620 and to indicate resource allocations.

In step 1604, the neighboring ambient IoT devices 1620 transmit, to the cluster head 1610, backscattered signals including control information and payload.

In step 1605, the cluster head 1610 combines the received transmissions from the neighboring ambient IoT devices 1620, and transmits a single message including the combined transmissions to the gNB 1600.

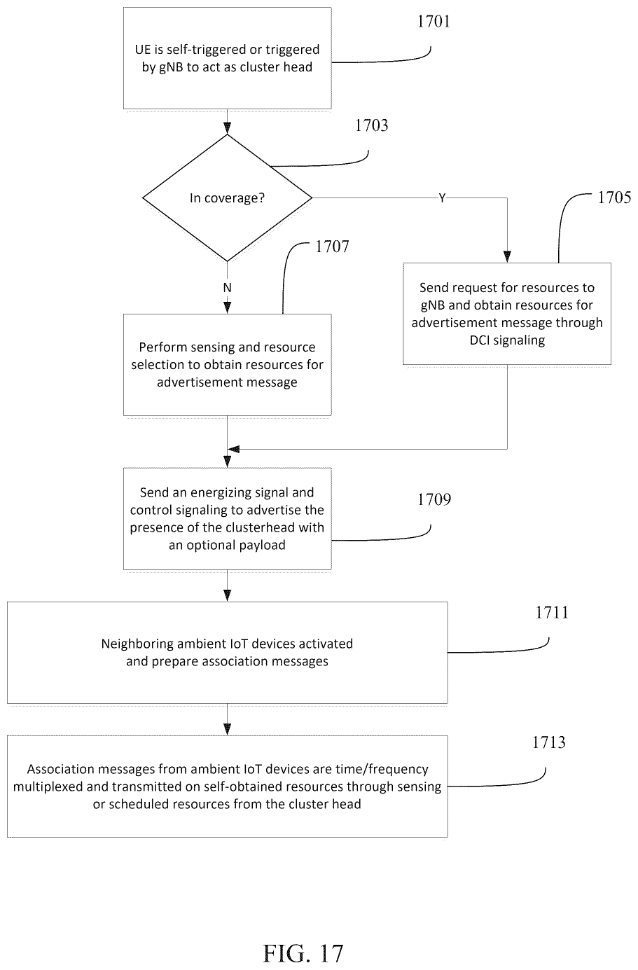

FIG. 17 is a flowchart illustrating a clustering procedure for ambient IoT devices, according to an embodiment.

Referring to FIG. 17, in step 1701, a UE is self-triggered or triggered by a gNB to act as a cluster head.

In step 1703, the UE determines if it is actively in coverage, i.e., already acting as a cluster head for at least one neighboring ambient IoT device.

If the UE is actively in coverage in step 1703, the UE sends a request to the gNB for resources and receives resources, e.g., for an advertisement message, via DCI from the gNB, in step 1705.

However, if the UE is not actively in coverage in step 1703, the UE performs sensing and resource selection in order to obtain resources sends a request to the gNB for resources for an advertisement message, in step 1707.

In step 1709, the UE sends an energizing signal and a control signal (with an optional payload), advertising its presence as a cluster head.

In step 1711, neighboring ambient IoT devices are activated in response to the energizing signal and the control signal, and prepare association messages.

In step 1713, the UE receives the association messages from the neighboring ambient IoT devices. As described above, the association messages may be time/frequency multiplexed (e.g., through backscattering) on self-obtained resources through sensing or on resources scheduled by the UE acting as the cluster head.

In accordance with the above-described embodiments, a gNB can schedule resources for an advertisement message from a cluster head UE as well as responses from ambient IoT devices using a new DCI format.

Additionally, the cluster head UE can perform sensing to identify future reserved resources by its neighbors (e.g., through 1st or 2nd stage SCI) and accordingly select a multi- slot resource for transmitting its advertisement message as well as the responses from the ambient IoT devices.

The cluster head can also perform a contiguous sensing to detect all the future reservations by its neighbors and accordingly select multi-slot resources to assign to its cluster members.

The cluster head can be assigned resources by the gNB, which can be used by its cluster members to transmit their information to the cluster head.

The cluster head may send an energizing signal (e.g., for Type A and Type B UEs) to activate ambient IoT devices followed by control signaling for scheduling resources (e.g., Device ID, time slot, and carrier frequency).

The cluster head can use one or more TRIV and FRIV fields to indicate assigned resources to neighboring ambient IoT devices within a cluster.

The cluster head can indicate one or more destination IDs in its control signaling to indicate scheduled ambient IoT devices.

The cluster head can send an energizing signal over a pre-configured frequency to perform a broadcast or groupcast triggering of neighboring ambient IoT devices as well as priority based triggering of neighboring ambient IoT devices.

Priority based triggering of ambient IoT devices may be utilized based on ambient IoT device location (e.g., when a large number of ambient IoT devices are expected to be triggered in a given location).

CBR measurements can be performed by ambient IoT devices to assist a cluster head in resource scheduling.

Accessible resources and transmitted power can be dependent on a measured CBR falling below a (pre)-configured priority-based threshold per resource pool.

A cluster head/device can use a one-bit field in control signaling or a MAC CE to indicate combining of transmissions from multiple ambient IoT devices at the cluster head.

The combining of messages at a cluster head from multiple ambient IoT devices can be enabled or disabled based on a resource pool (pre)-configuration.

### Sensing Based Random Resource Selection

Random resource selection is an appealing approach for ambient IoT devices due to their limited capabilities and minimal energy storage. However, given the relatively large number of ambient IoT devices that are expected to be deployed, using a random resource selections may result in a collisions, negatively impacting system performance.

According to an embodiment of the disclosure, to address this type of issue, energy detection may be performed for a duration before performing a backscattered transmission. In particular, a UE that randomly selects a carrier for backscattering may be required to perform energy detection on this carrier and may be permitted to subsequently transmit only if the measured energy is below a pre-configured threshold for a given duration. For example, this duration can be dependent on an ambient IoT device ID (e.g., by applying a hash function on the ambient IoT device ID to obtain the sensing duration) or on an ambient IoT device type (e.g., a Type A device can be (pre)-configured to have a longer sensing duration when compared to a Type C device).

Alternatively, the duration can be randomly selected from a window, wherein boundaries of the window may be based on a priority of a transmission and a duration of an energizing signal.

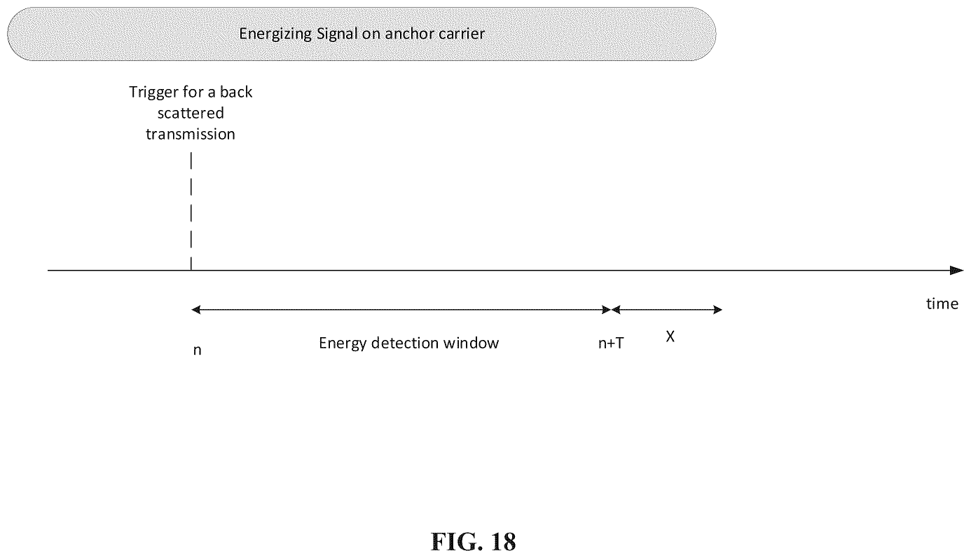

FIG. 18 illustrates a sensing window of a resource selection for backscattering by ambient IoT devices, according to an embodiment.

Referring to FIG. 18, a source (e.g., a cluster head, a gNB, a UE, etc.) can indicate the duration of its energizing signal in control signaling or based on a (pre)-configuration. Subsequently, an ambient IoT device triggered for transmission at slot n can establish a window for performing energy detection between n and n+T, where T is dependent on the transmission priority and T is X slots prior to a last slot in which the energizing signal will be transmitted. In this case, X is the number of slots that will be used by the ambient IoT device to send its backscattered signal to the source and the processing time delay required by the ambient IoT device to generate the backscattered signal.

A restriction on the value of T to be within the energizing signal window can be dependent on the device type. For example, ambient IoT Type C devices may be able to have a window duration that extends beyond the energizing signal duration.

In addition, high priority transmissions may be allowed to perform their backscattered transmissions even if the channel is detected as occupied. For example, an ambient IoT device with priority above a (pre)-configured threshold may have one or more potential starting positions to perform its transmission. Subsequently, if the device is not able to detect an unoccupied channel for its randomly selected duration before the first potential starting position, it can then randomly select one of the potential starting positions and perform its transmission. Alternatively, the ambient IoT device can randomly select a resource from a (pre)-configured time/channel resource set.

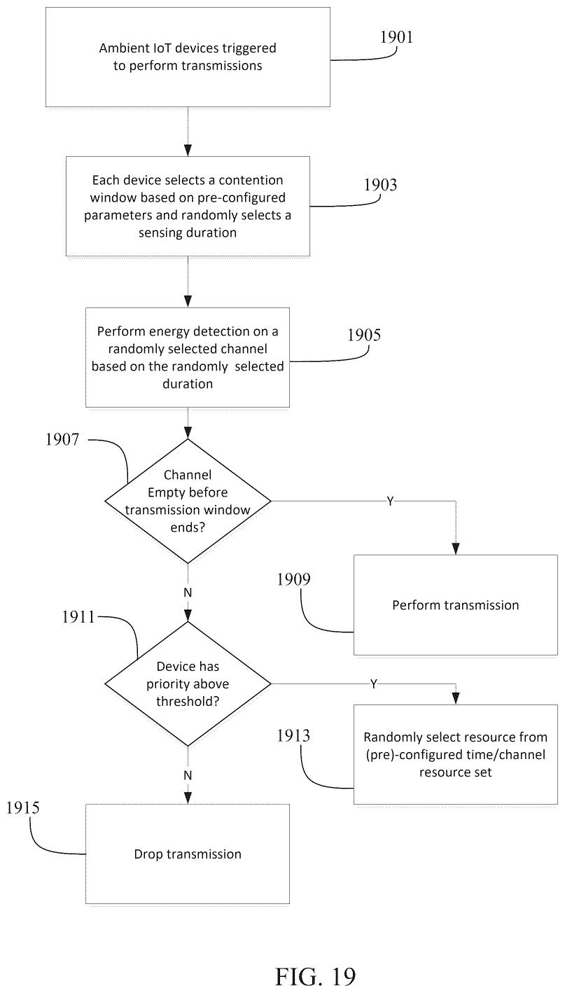

FIG. 19 is a flow chart illustrating a random access procedure for an ambient IoT system based on energy detection, according to an embodiment.

Referring to FIG. 19, in step 1901, one or more ambient IoT devices are triggered to perform a transmission (e.g., by a gNB or a UE).

In step 1903, each of one or more ambient IoT devices selects a contention window based on pre-configured parameters and randomly selects a sensing duration.

In step 1905, each of one or more ambient IoT devices performs energy detection on a randomly selected channel, based on the randomly selected sensing duration.

In step 1907, an ambient IoT device determines if the randomly selected channel is empty before the transmission window ends.

If the randomly selected channel is empty in step 1907, the ambient IoT device performs a transmission on the randomly selected channel in step 1909.

However, if the randomly selected channel is not empty in step 1907, the ambient IoT device determines if it has priority satisfying a threshold in step 1911.

If the ambient IoT device determines that it has priority satisfying a threshold in step 1911, the ambient IoT device randomly selects a resource from a (pre)-configured time/channel resource set and performs a transmission using the randomly selected resource in step 1913.

However, if the ambient IoT device determines that it has priority satisfying a threshold in step 1911, the ambient IoT device drops the transmission in step 1915.

In accordance with the above-described embodiments, when randomly selecting a resource for transmission, an ambient IoT device may be required to perform sensing for a randomly selected duration before transmitting, in order to avoid collisions with neighboring devices.

A duration for energy detection can be selected randomly from a window, wherein window boundaries depends on a device type, a transmission priority, a duration of an energizing signal, etc.

Additionally, an ambient IoT device with a priority satisfying (e.g., above) a (pre)-configured threshold may randomly select a starting position out of a (pre)-configured set for its backscattered transmission irrespective of its energy detection outcome.

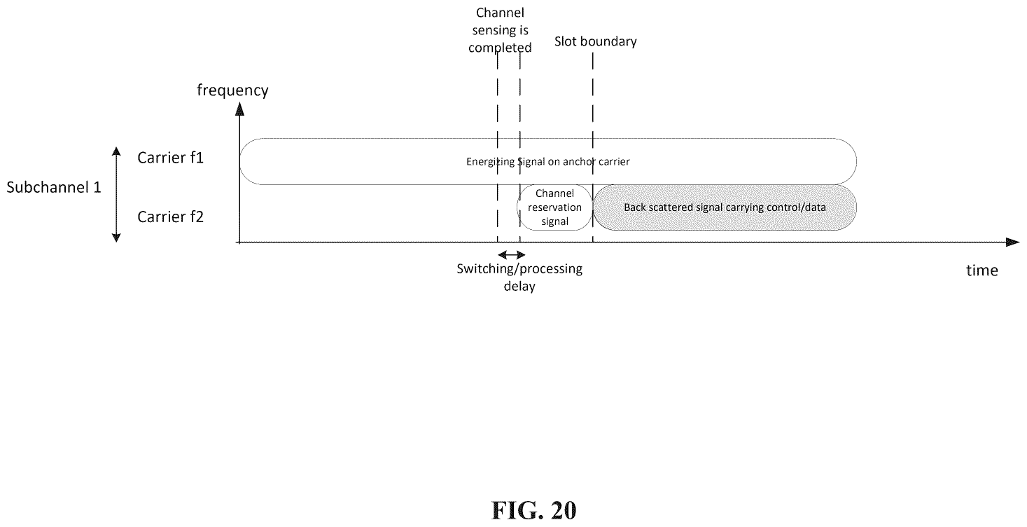

FIG. 20 illustrates an example of a channel reservation signal being used to occupy a channel before a slot boundary, according to an embodiment.

Referring to FIG. 20, in some cases, an ambient IoT device may have a successful energy detection at a point in time that is not aligned with a slot boundary. When this occurs, the ambient IoT device can initiate a backscattering of an energizing signal to occupy a channel and accordingly prevent other neighboring ambient IoT devices from interfering with its transmitted signal.

For Type A and Type B devices, a channel reservation signal can simply be a reflection of an energizing signal with no modulation or modulated with dummy bits. In case of Type C devices, a channel reservation signal can be transmitted by the device itself. The channel reservation signal can also use a different modulation scheme (e.g., amplitude-shift keying (ASK)), when compared to an ON-OFF keying of a regular backscattered transmission to maintain a channel. However, based on a resource pool (pre)-configuration, the channel reservation signal may be restricted only to backscattering without amplification in order to avoid blocking transmissions of neighboring ambient IoT devices.

In accordance with the above-described embodiments, an ambient IoT device may perform a dummy transmission, e.g., transmit a channel reservation signal or an energy occupying signal, to occupy a resource if its sensing was successful before a targeted slot boundary for transmission. The dummy transmission used to occupy the channel can rely on different modulation scheme (e.g., ASK) to maintain channel occupancy.

Additionally, the amplification power of an energy occupying signal can be restricted to prevent the blocking of a large number of ambient IoT devices.

According to an embodiment of the disclosure, to alleviate a burden on ambient IoT devices, a source can be responsible to perform energy detection before transmitting an energizing signal to the ambient IoT devices. For example, the source may perform sensing for a randomly selected duration before sending the energizing signal on a given carrier. This may be beneficial to avoid collisions between neighboring sources (e.g., neighboring devices) when resources are randomly selected by the devices (i.e., these resources are not selected based on sensing and are not assigned centrally by a gNB). The resource can then be scheduled by the source in a downlink transmission.

Multiple locations of an energizing signal can be (pre)-configured, wherein each location may be used to indicate a message to the ambient IoT devices. For example, for multiple subchannels, the presence of an energizing signal on a carrier within a subchannel can be used to indicate whether the subchannel can be used by the ambient IoT devices for the current transmission or is currently blocked by an ambient IoT device performing a transmission. More specifically, a subchannel contains multiple carriers (e.g., f1, f2, f3, and f4). If the energizing signal exists on f1, then the subchannel is accessible and f2, f3, and f4 can be used; otherwise, devices should use a different subchannel.

According to the above-described embodiments, to reduce complexity of ambient IoT devices, energy detection can be performed by a source, before transmitting an energizing signal to the ambient IoT devices. Additionally, the source can schedule the neighboring ambient IoT devices through the transmission of its energizing signal.

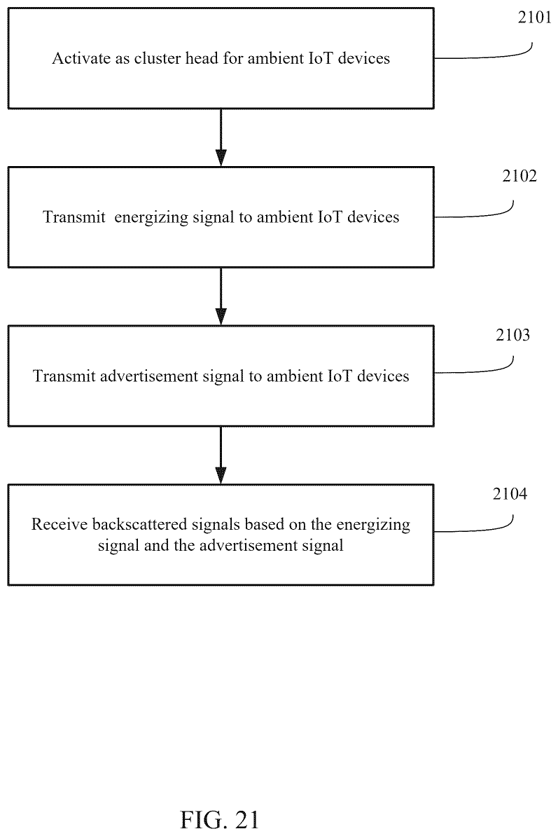

FIG. 21 is a flow chart illustrating a method performed by a cluster head device, according to an embodiment.

Referring to FIG. 21, in step 2101, a first device, e.g., an intermediate node such as a UE, activates as a cluster head for ambient IoT devices. For example, the first device may activate as the cluster head for the ambient IoT devices in response to detecting the ambient IoT devices or receiving, from a second device, e.g., base station, a signal triggering the first device to activate as the cluster head. Also, the first device is preferably not detecting an energizing signal with a signal strength above an pre-configured threshold, as this would indicate that another cluster is nearby, sending the energizing signal. In this, the first device should not activate.

In step 2102, the first device transmits at least one energizing signal to the ambient IoT devices.

In step 2103, the first device transmits an advertisement signal to the ambient IoT devices. As described above, the advertisement signal may include control information configuring the ambient IoT devices to respond to the first device at different times and/or over different carrier frequencies in order to avoid collisions.

In step 2104, the first device receives, from the ambient IoT devices, backscattered signals based on the energizing and advertisement signals. For example, the first device may then collect all of the response signals from the ambient IoT devices and provide them to the base station in a single message.

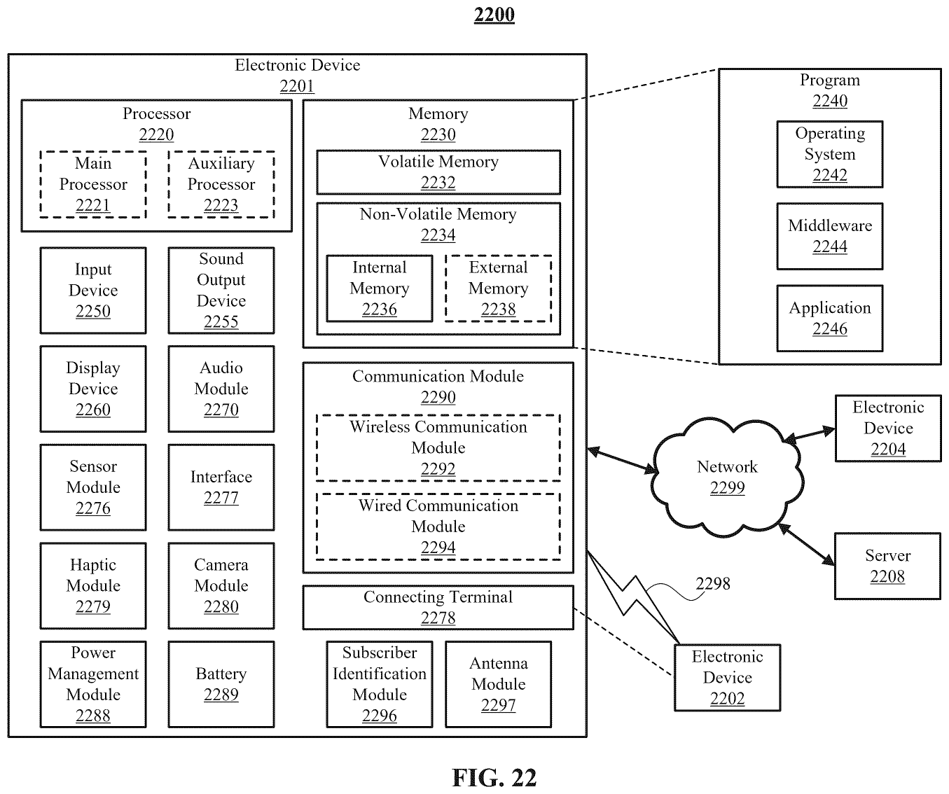

FIG. 22 is a block diagram of an electronic device in a network environment 2200, according to an embodiment.

Referring to FIG. 22, an electronic device 2201 in a network environment 2200 may communicate with an electronic device 2202 via a first network 2298 (e.g., a short-range wireless communication network), or an electronic device 2204 or a server 2208 via a second network 2299 (e.g., a long-range wireless communication network). The electronic device 2201 may communicate with the electronic device 2204 via the server 2208. The electronic device 2201 may include a processor 2220, a memory 2230, an input device 2250, a sound output device 2255, a display device 2260, an audio module 2270, a sensor module 2276, an interface 2277, a haptic module 2279, a camera module 2280, a power management module 2288, a battery 2289, a communication module 2290, a subscriber identification module (SIM) card 2296, or an antenna module 2297. In one embodiment, at least one (e.g., the display device 2260 or the camera module 2280) of the components may be omitted from the electronic device 2201, or one or more other components may be added to the electronic device 2201. Some of the components may be implemented as a single integrated circuit (IC). For example, the sensor module 2276 (e.g., a fingerprint sensor, an iris sensor, or an illuminance sensor) may be embedded in the display device 2260 (e.g., a display).

The processor 2220 may execute software (e.g., a program 2240) to control at least one other component (e.g., a hardware or a software component) of the electronic device 2201 coupled with the processor 2220 and may perform various data processing or computations. For example, the processor 2220 may execute software (e.g., a program 2240) to control the electronic device 2201 to perform a method as illustrated in FIG. 17, 19, or 21.

As at least part of the data processing or computations, the processor 2220 may load a command or data received from another component (e.g., the sensor module 2276 or the communication module 2290) in volatile memory 2232, process the command or the data stored in the volatile memory 2232, and store resulting data in non-volatile memory 2234. The processor 2220 may include a main processor 2221 (e.g., a central processing unit (CPU) or an application processor (AP)), and an auxiliary processor 2223 (e.g., a graphics processing unit (GPU), an image signal processor (ISP), a sensor hub processor, or a communication processor (CP)) that is operable independently from, or in conjunction with, the main processor 2221. Additionally or alternatively, the auxiliary processor 2223 may be adapted to consume less power than the main processor 2221, or execute a particular function. The auxiliary processor 2223 may be implemented as being separate from, or a part of, the main processor 2221.

The auxiliary processor 2223 may control at least some of the functions or states related to at least one component (e.g., the display device 2260, the sensor module 2276, or the communication module 2290) among the components of the electronic device 2201, instead of the main processor 2221 while the main processor 2221 is in an inactive (e.g., sleep) state, or together with the main processor 2221 while the main processor 2221 is in an active state (e.g., executing an application). The auxiliary processor 2223 (e.g., an image signal processor or a communication processor) may be implemented as part of another component (e.g., the camera module 2280 or the communication module 2290) functionally related to the auxiliary processor 2223.

The memory 2230 may store various data used by at least one component (e.g., the processor 2220 or the sensor module 2276) of the electronic device 2201. The various data may include, for example, software (e.g., the program 2240) and input data or output data for a command related thereto. The memory 2230 may include the volatile memory 2232 or the non-volatile memory 2234. Non-volatile memory 2234 may include internal memory 2236 and/or external memory 2238.

The program 2240 may be stored in the memory 2230 as software, and may include, for example, an operating system (OS) 2242, middleware 2244, or an application 2246.

The input device 2250 may receive a command or data to be used by another component (e.g., the processor 2220) of the electronic device 2201, from the outside (e.g., a user) of the electronic device 2201. The input device 2250 may include, for example, a microphone, a mouse, or a keyboard.

The sound output device 2255 may output sound signals to the outside of the electronic device 2201. The sound output device 2255 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 2260 may visually provide information to the outside (e.g., a user) of the electronic device 2201. The display device 2260 may include, for example, a display, a hologram device, or a projector and control circuitry to control a corresponding one of the display, hologram device, and projector. The display device 2260 may include touch circuitry adapted to detect a touch, or sensor circuitry (e.g., a pressure sensor) adapted to measure the intensity of force incurred by the touch.

The audio module 2270 may convert a sound into an electrical signal and vice versa. The audio module 2270 may obtain the sound via the input device 2250 or output the sound via the sound output device 2255 or a headphone of an external electronic device 2202 directly (e.g., wired) or wirelessly coupled with the electronic device 2201.

The sensor module 2276 may detect an operational state (e.g., power or temperature) of the electronic device 2201 or an environmental state (e.g., a state of a user) external to the electronic device 2201, and then generate an electrical signal or data value corresponding to the detected state. The sensor module 2276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 2277 may support one or more specified protocols to be used for the electronic device 2201 to be coupled with the external electronic device 2202 directly (e.g., wired) or wirelessly. The interface 2277 may include, for example, a high-definition multimedia interface (HDMI), a universal serial bus (USB) interface, a secure digital (SD) card interface, or an audio interface.

A connecting terminal 2278 may include a connector via which the electronic device 2201 may be physically connected with the external electronic device 2202. The connecting terminal 2278 may include, for example, an HDMI connector, a USB connector, an SD card connector, or an audio connector (e.g., a headphone connector).

The haptic module 2279 may convert an electrical signal into a mechanical stimulus (e.g., a vibration or a movement) or an electrical stimulus which may be recognized by a user via tactile sensation or kinesthetic sensation. The haptic module 2279 may include, for example, a motor, a piezoelectric element, or an electrical stimulator.

The camera module 2280 may capture a still image or moving images. The camera module 2280 may include one or more lenses, image sensors, image signal processors, or flashes. The power management module 2288 may manage power supplied to the electronic device 2201. The power management module 2288 may be implemented as at least part of, for example, a power management integrated circuit (PMIC).

The battery 2289 may supply power to at least one component of the electronic device 2201. The battery 2289 may include, for example, a primary cell which is not rechargeable, a secondary cell which is rechargeable, or a fuel cell.

The communication module 2290 may support establishing a direct (e.g., wired) communication channel or a wireless communication channel between the electronic device 2201 and the external electronic device (e.g., the electronic device 2202, the electronic device 2204, or the server 2208) and performing communication via the established communication channel. The communication module 2290 may include one or more communication processors that are operable independently from the processor 2220 (e.g., the AP) and supports a direct (e.g., wired) communication or a wireless communication. The communication module 2290 may include a wireless communication module 2292 (e.g., a cellular communication module, a short-range wireless communication module, or a global navigation satellite system (GNSS) communication module) or a wired communication module 2294 (e.g., a local area network (LAN) communication module or a power line communication (PLC) module). A corresponding one of these communication modules may communicate with the external electronic device via the first network 2298 (e.g., a short-range communication network, such as BLUETOOTH™, wireless-fidelity (Wi-Fi) direct, or a standard of the Infrared Data Association (IrDA)) or the second network 2299 (e.g., a long-range communication network, such as a cellular network, the Internet, or a computer network (e.g., LAN or wide area network

(WAN)). These various types of communication modules may be implemented as a single component (e.g., a single IC), or may be implemented as multiple components (e.g., multiple ICs) that are separate from each other. The wireless communication module 2292 may identify and authenticate the electronic device 2201 in a communication network, such as the first network 2298 or the second network 2299, using subscriber information (e.g., international mobile subscriber identity (IMSI)) stored in the subscriber identification module 2296.

The antenna module 2297 may transmit or receive a signal or power to or from the outside (e.g., the external electronic device) of the electronic device 2201. The antenna module 2297 may include one or more antennas, and, therefrom, at least one antenna appropriate for a communication scheme used in the communication network, such as the first network 2298 or the second network 2299, may be selected, for example, by the communication module 2290 (e.g., the wireless communication module 2292). The signal or the power may then be transmitted or received between the communication module 2290 and the external electronic device via the selected at least one antenna.

Commands or data may be transmitted or received between the electronic device 2201 and the external electronic device 2204 via the server 2208 coupled with the second network 2299. Each of the electronic devices 2202 and 2204 may be a device of a same type as, or a different type, from the electronic device 2201. All or some of operations to be executed at the electronic device 2201 may be executed at one or more of the external electronic devices 2202, 2204, or 2208. For example, if the electronic device 2201 should perform a function or a service automatically, or in response to a request from a user or another device, the electronic device 2201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 2201. The electronic device 2201 may provide the outcome, with or without further processing of the outcome, as at least part of a reply to the request. To that end, a cloud computing, distributed computing, or client-server computing technology may be used, for example.

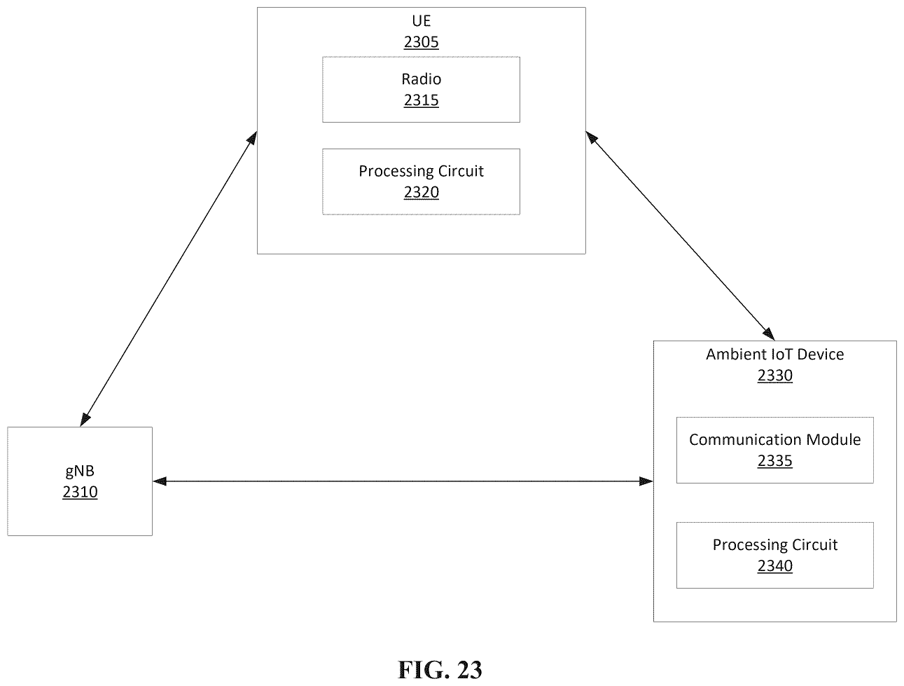

FIG. 23 shows a system including an ambient IoT device, a UE, and a gNB in communication with each other.

Referring to FIG. 22, the UE 1305 may include a radio 2315 and a processing circuit (or a means for processing) 2320, which may perform various methods disclosed herein, e.g., the method illustrated in FIG. 17, 19, or 21. For example, the processing circuit 2320 may receive, via the radio 2315, signals from the network node (gNB) 2310, and the processing circuit 2320 may transmit, via the radio 2315, signals to the gNB 2310. The processing circuit 2320 may also receive, via the radio 2315, signals from the ambient IoT device 2330, and the processing circuit 2320 may transmit, via the radio 2315, signals to ambient IoT device 1330.

The ambient IoT device 2330 may include a communication module 2335 and a processing circuit (or a means for processing) 2340, which may perform various methods disclosed herein e.g., the method illustrated in FIG. 17, 19, or 21. For example, the processing circuit 2340 may receive, via the communication module 2335, signals from the network node (gNB) 2310, and the processing circuit 2340 may transmit, via the communication module 2335, signals to the gNB 2310. The processing circuit 2340 may also receive, via the communication module 2335, signals from the UE 2305, and the processing circuit 2340 may transmit, via the communication module 2335, signals to the UE 2305.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by a first device in an ambient Internet of things (IoT) system, the method comprising:
activating as a cluster head for ambient IoT devices, in response to a first condition being met;
transmitting a first energizing signal to the ambient IoT devices on a first carrier frequency;
transmitting an advertisement signal to the ambient IoT devices; and
receiving, from a first ambient IoT device among the ambient IoT devices, a first backscattered signal based on the first energizing signal and the advertisement signal.

2. The method of claim 1, wherein the first condition comprises detecting the ambient IoT devices or receiving, from a second device, a signal triggering the first device to activate as the cluster head and indicating available resources for transmitting the advertisement signal.

3. The method of claim 2, wherein the first condition further comprises energizing signal detection from neighboring clusters satisfying a predetermined threshold.

4. The method of claim 1, further comprising transmitting a second energizing signal to the ambient IoT devices,
wherein the second energizing signal is transmitted on a second carrier frequency, different than the first carrier frequency.

5. The method of claim 4, wherein the first backscattered signal is received by the first device over the first carrier frequency, based on the first ambient IoT device selecting the first energizing signal.

6. The method of claim 1, wherein the first backscattered signal is received by the first device over the a second carrier frequency, based on the first ambient IoT device utilizing a conversion offset from the first carrier frequency for transmitting the first backscattered signal.

7. The method of claim 1, further comprising receiving, from a second ambient IoT device among the ambient IoT devices, a second backscattered signal based on the first energizing signal and the advertisement signal,
wherein the first ambient IoT device applies a first random backoff duration before transmitting the first backscattered signal,
wherein the second ambient IoT device applies a second random backoff duration before transmitting the second backscattered signal, and
wherein the first device receives the first backscattered signal and the second backscattered signal at different times.

8. The method of claim 7, wherein the first random backoff duration is based on a first priority of the first ambient IoT device, and
wherein the second random backoff duration is based on a second priority of the second ambient IoT device.

9. The method of claim 7, wherein the first random backoff duration is based on a first device identification (ID) or a first device type of the first ambient IoT device, and
wherein the second random backoff duration is based on a second device ID or a second device type of the second ambient IoT device.

10. The method of claim 1, wherein the first backscattered signal is received on a carrier frequency identified as being empty based on energy detection performed by the first ambient IoT device.

11. The method of claim 1, wherein the advertisement signal includes an association between a type of the first ambient IoT device and at least one of a time allocation or a carrier frequency over which to send the first backscattered signal, and
wherein the first backscattered signal is received by the first device on the at least one of the time allocation or the carrier frequency associated with the type of the first ambient IoT device.

12. The method of claim 11, wherein the advertisement signal includes an association between an identification (ID) of the first ambient IoT device and a carrier frequency over which to send the first backscattered signal, and
wherein the first backscattered signal is received by the first device on the carrier frequency associated with the ID of the first ambient IoT device.

13. The method of claim 1, wherein the advertisement signal includes at least one of an identification (ID) of the first device, a capability indication of the first device, targeted ambient IoT device IDs, or an in-coverage indication.

14. The method of claim 1, further receiving, from the first ambient IoT device, one or more repetitions of the first backscattered signal,
wherein a number of the one or more repetitions is preconfigured or based on a device priority of the first ambient IoT device.

15. The method of claim 1, further comprising:
performing energy detection on a set of carrier frequencies; and
identifying an unoccupied carrier frequency among the set of carrier frequencies based on the energy detection,
wherein the advertisement signal includes an indication of the unoccupied carrier frequency, and
wherein the first backscattered signal is received on the unoccupied carrier frequency.

16. The method of claim 15, wherein the energy detection is performed during a pre-configured window.

17. The method of claim 1, wherein the advertisement signal includes a groupcast identification (ID) or a reserved broadcast ID for triggering a subset of the ambient IoT devices including the first ambient IoT device to transmit response signals to the first device.

18. The method of claim 1, wherein the advertisement signal is transmitted on a carrier frequency that is preconfigured to trigger a subset of the ambient IoT devices including the first ambient IoT device to transmit response signals to the first device.

19. The method of claim 1, further comprising:
transmitting, to the ambient IoT devices, a control signal for triggering channel busy ratio (CBR) measurements by the ambient IoT devices;
receiving, from the ambient IoT devices, CBR measurements; and
performing resource allocation for the ambient IoT devices based the CBR measurements.

20. A first device operable in an ambient Internet of things (IoT) system, the first device comprising:
a transceiver; and
a processor configured to:
activate the first device as a cluster head for ambient IoT devices, in response to a first condition being met,
transmit, via the transceiver, a first energizing signal to the ambient IoT devices on a first carrier frequency,
transmit, via the transceiver, an advertisement signal to the ambient IoT devices, and
receive, from a first ambient IoT device among the ambient IoT devices, a first backscattered signal based on the first energizing signal and the advertisement signal.
